(19) United States
(12) Patent Application Publication
(10) Pub. No.: US 2008/0067980 A1
(43) Pub. Date: Mar. 20, 2008

(54) Method and Apparatus for Using Momentary Switches in Pulsed Power Applications

(75) Inventor: Frederick William MacDougall, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: General Atomics, San Diego, CA (US)

(21) Appl. No.: 11/844,889

(22) Filed: Aug. 24, 2007

Related U.S. Application Data
(60) Provisional application No. 60/823,495, filed on Aug. 24, 2006.

(51) Int. Cl. H01M 10/44; H01H 3/02; H01M 10/46; H02J 7/00

(52) U.S. Cl. 320/139; 200/52 R; 320/166

(57) ABSTRACT

A capacitor based pulse forming network includes a plurality of inductors adapted to be coupled to a load, a plurality of capacitor units, and a plurality of switches. Each switch couples a respective capacitor unit to a respective inductor. Multiple capacitor units are coupled to each inductor by separate switches and are adapted to be switched to a closed position to discharge the respective capacitor unit for a time interval of less than about 50 milliseconds. The plurality of switches are adapted to non-simultaneously discharge at least some of the multiple capacitor units to provide non-simultaneous pulses through a given inductor to the load and not through other inductors.

### RELATED APPLICATION DATA

This application claims priority to Provisional Application Ser. No. 60/823,495, filed Aug. 24, 2006, the disclosure of which is hereby incorporated by reference herein in its entirety. This application is related to U.S. patent application Ser. No. 11/425,134, filed Jun. 19, 2006, the disclosure of which incorporated herein by reference as though fully set forth.

### BACKGROUND OF THE INVENTION

1. Field of the Invention

The present invention relates generally to the use of momentary switches in pulsed power applications, and more specifically relates to using momentary switches for switching capacitor banks of a pulse forming network to a load.

2. Discussion of the Related Art

In certain applications where high power sources (e.g., power lines, batteries) are unable to deliver high levels of peak power, pulse forming networks having high-energy density capacitors are often used. In these applications, the capacitors are slowly charged from the power source and then quickly discharged for short time periods to provide pulsed energy at high peak power levels. The capacitors are typically used with large inductors to restrict the flow of energy from the capacitors and to establish the frequency, period and shape of the output pulse from the network.

FIG. 1 illustrates a known pulse forming network 100 including a number n of modules 102ₙ (where n=1, 2, . . . , N) coupled to a load 104. Each module 102ₙ includes a bank of capacitors 106ₙ coupled to the load 104 through an inductor 110n via a switch 108ₙ and an anti-reversing diode 112n. In operation, each bank of capacitors 106ₙ is charged while the switches 108ₙ are open. Once charged, groups of modules 102ₙ are sequentially discharged to the load 104. For example, initially, a predetermined number of modules (a first set of modules) are discharged at once to the load 104. That is, the switches 108 for the first set of modules are closed at once, discharging the energy stored through the inductors 110 corresponding to the first set of modules to the load producing a current pulse to the load 104. At a point in time after the discharge of the first set of modules is initiated, a second set of modules 102 are discharged at once to the load producing a second current pulse to the load. After the initiation of the discharge of the second set of modules, a third set of modules is discharged at once to the load producing a third current pulse, and so on. The pulses add, creating the output pulse waveform at the load. The anti-reversing diodes 112n of each module 102n prevent the voltage from reversing on the capacitors (which prevents the capacitors from recharging from their own discharge current) and ensure that the current discharging from other sets of modules flows to the load 104. Typically, in most high power pulse forming networks, there are 3-5 sets of modules, each set being discharged at the same time, the sets being discharged in sequence.

FIG. 2 is a graph of current over time illustrating a typical pulse waveform formed by the pulse forming network 100 of FIG. 1 including 72 modules (i.e., N=72) divided into 3 sets of modules. For example, modules 1021-10224 are then discharged at the same time forming current pulse 202, modules 10225-10248 are then discharged at the same time forming pulse 204, and modules 10249-10272 are discharged at the same time forming pulse 206. The pulses add to produce waveform 208 as compared to the desired flat top waveform 201, emulating a square or rectangular pulse.

This pulse forming network results in many inductors (e.g., 72 in this example) representing a large mass in the pulse forming network. Furthermore, the waveform 208 does not accurately track the desired flat top waveform 201, especially at the end of the waveform. Additionally, significant energy is wasted at the end of the waveform (which is illustrated as area 212 under the curve of waveform 208). Accordingly, the energy storage requirements of the pulse forming network 100 must be increased in order to provide enough current in view of the wasted energy. Requiring many large inductors and needing to provide additional energy storage due to wasted energy adds to the mass and size of the pulse forming network, as well as increases the flux generated by the inductors.

Another problem with current pulse forming networks is that the switches in communication with the capacitors are typically semiconductor switches, such as metal-oxide-semiconductor field-effect transistor (“MOSFETs”) or junction gate field-effect transistor (“JFETs”). Solid state or semiconductor switches, however, cannot handle quick changes in current, i.e., they are limited by di/dt.

Vacuum bottles have been used as switches, but never in conjunction with a pulse-forming network. Vacuum bottles can be rapidly moved from an “open” position to a “closed” position by forcing one contact toward the other contact. When forcing one contact toward the other, the contacts have a natural tendency to “bounce” back into the open position. Current vacuum bottle switching systems dampen this bouncing effect to ensure that the contacts remain closed for a specified period of time so that the opening of the vacuum bottles can be controlled. Currently-used vacuum bottle switching systems are transitioned from an “open” state to a “closed” state and typically remain in the “closed” state for a relatively long amount of time.

### SUMMARY OF THE INVENTION

An embodiment of the invention is directed to a capacitor based pulse forming network. The network includes a plurality of inductors adapted to be coupled to a load, as well as a plurality of capacitor units. A plurality of switches are also included. Each switch couples a respective capacitor unit to a respective inductor. Multiple capacitor units are coupled to each inductor by separate switches and are adapted to be switched to a closed position to discharge the respective capacitor unit for a time interval of less than about 50 milliseconds. The plurality of switches are adapted to non-simultaneously discharge at least some of the multiple capacitor units to provide non-simultaneous pulses through a given inductor to the load and not through other inductors.

An embodiment of the invention is directed to a method of operating a mechanically moveable switch. A mechanically moveable switch is coupled between two electrical components. Contacts of the mechanically moveable switch are closed to allow energy to conduct through the mechanically moveable switch. The mechanically moveable switch is opened such that a period of time that the mechanically moveable switch is in a closed state is less than about 50 milliseconds.

An embodiment of the invention is directed to a system for generating pulsed power to perform a predefined function. The system includes a pulse forming network having a plurality of inductors adapted to be coupled to a load, a plurality of capacitor units and a plurality of momentary switches, each momentary switch coupling a respective capacitor unit to a respective inductor. Multiple capacitor units are coupled to each inductor by separate momentary switches and are adapted to be switched to a closed position to discharge the respective capacitor unit for a time interval of less than about 50 milliseconds. The plurality of momentary switches are adapted to non-simultaneously discharge at least some of the multiple capacitor units to provide non-simultaneous pulses through a given inductor to the load and not through other inductors.

The system includes a timing controller to control switching of the separate momentary switches. An apparatus is adapted to receive the non-simultaneous pulses from the pulse forming network and perform a predefined function based on receipt of the non-simultaneous pulses.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present invention will be more apparent from the following more particular description thereof, presented in conjunction with the following drawings.

FIG. 1 is a diagram of a conventional pulse forming network which discharges energy storage capacitors through inductors.

FIG. 2 is a graph illustrating a typical pulse waveform formed by the pulse forming network of FIG. 1.

FIG. 3 is a diagram of a pulse forming network according to one embodiment of the invention.

FIG. 4 is a graph illustrating an output pulse waveform produced by one embodiment of the pulse forming network of FIG. 3.

FIG. 5 is a diagram of an energy storage module of the pulse forming network of FIG. 3 including a charging power supply and a timing controller in accordance with one embodiment of the invention.

FIG. 6 is a diagram of a portion of the timing controller of FIG. 5 for controlling the discharging of a capacitor unit of the pulse forming network of FIG. 3 according to one embodiment of the invention.

FIG. 7 illustrates a vacuum bottle according to at least one embodiment of the invention.

FIG. 8 illustrates a chart of what the voltage output waveform resulting from closing all three switches on a 3-phase bank of capacitors without coordinating the closing of the switches.

FIG. 9 illustrates the voltage output waveform resulting from closing all three switches on a 3-phase bank of capacitors with coordinating the closing of the switches.

FIG. 10 a flowchart illustrating the steps performed in accordance with one embodiment of the invention.

FIG. 11 is a schematic diagram of a rail gun application using a pulse forming network to provide energy to launch a projectile in accordance with several embodiments.

Corresponding reference characters indicate corresponding components throughout the several views of the drawings.

### DETAILED DESCRIPTION

The following description is not to be taken in a limiting sense, but is made merely for the purpose of describing the general principles of the preferred embodiments.

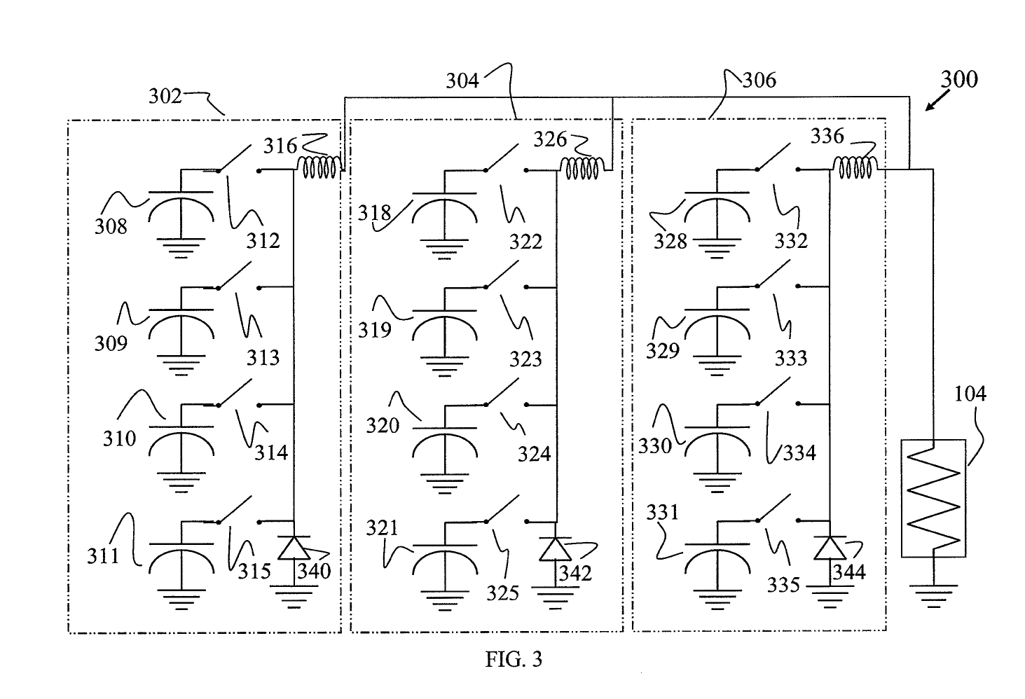

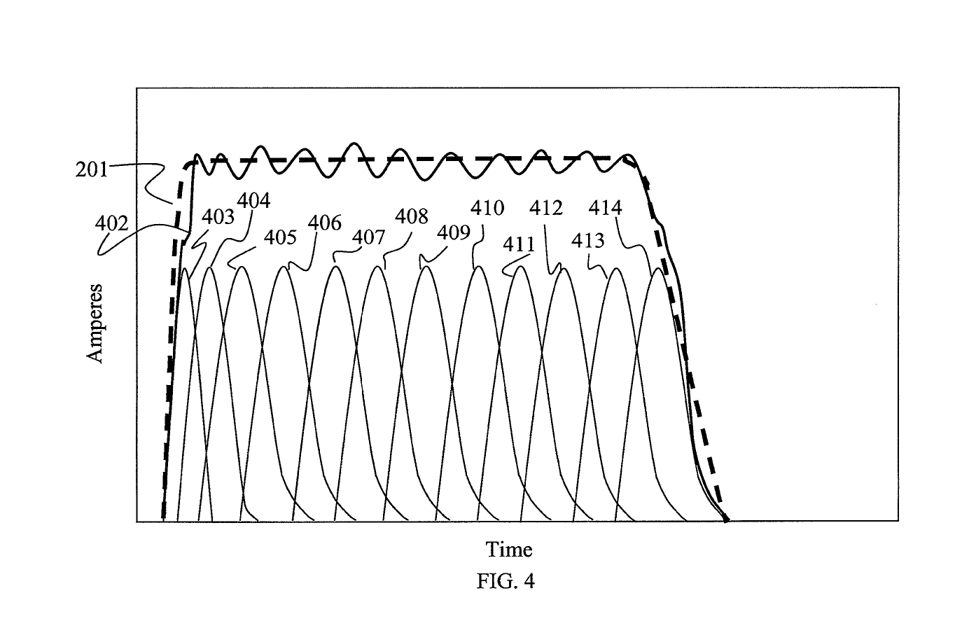

Referring first to FIG. 3, a diagram is shown of a pulse forming network according to one embodiment of the invention. Referring also to FIG. 4, a graph is shown illustrating an output pulse waveform produced by one embodiment of the pulse forming network of FIG. 3.

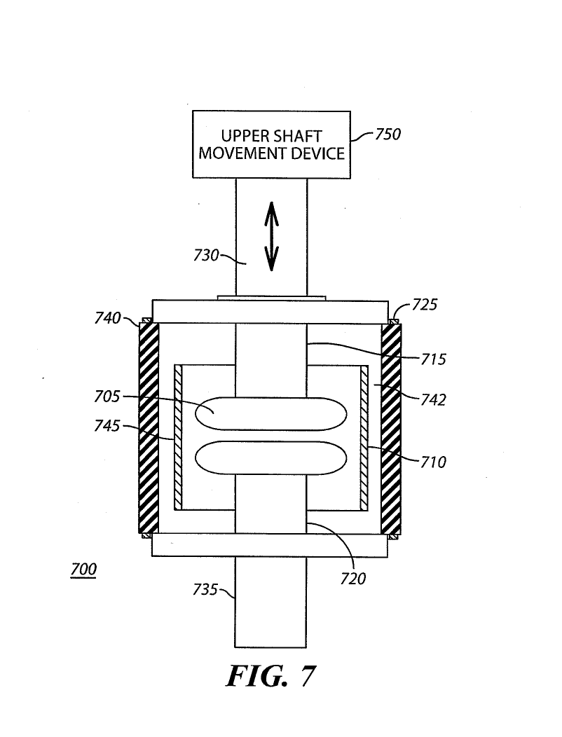

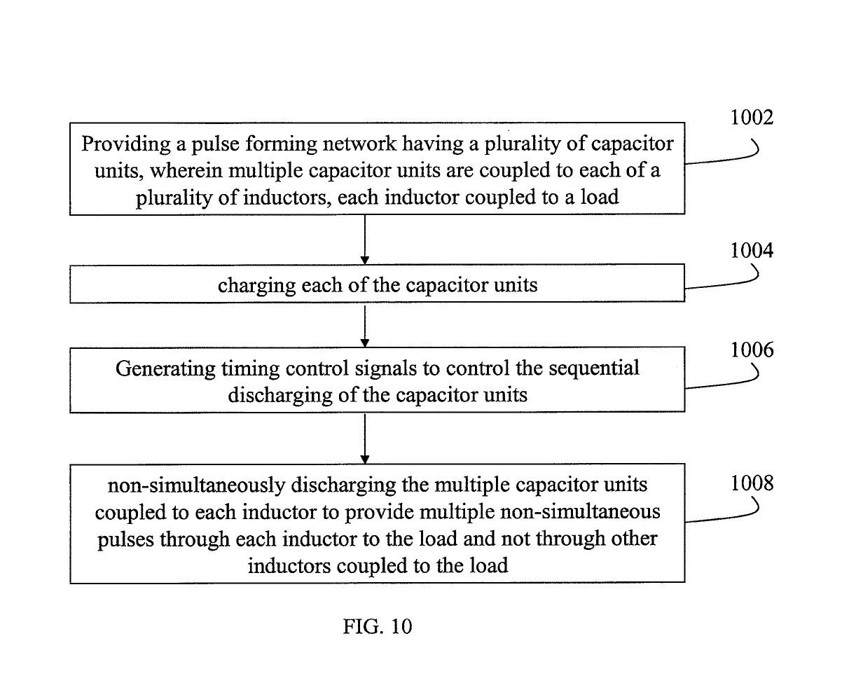

The pulse forming network 300 includes multiple capacitor units being switched through each inductor. Specifically, the pulse forming network 300 includes a plurality (e.g., three) energy storage modules 302, 304, 306 each coupled to a load 104. Each module 302, 304 and 306 includes a plurality (e.g., four) of capacitor units coupled to the load 104 through an inductor via a switch. Each module 302, 304, 306 also includes an anti-reversing diode (although in some embodiments, an anti-reversing diode is not present in all modules, for example, see FIG. 10). As illustrated, module 302 includes capacitor units 308, 309, 310 and 311, each coupled via one of switches 312, 313, 314 and 315 through inductor 316 to the load 104. Similarly, module 304 includes capacitor units 318, 319, 320 and 321, each coupled via one of switches 322, 323, 324 and 325 through inductor 326 to the load 104. And module 306 includes capacitor units 328, 329, 330 and 331, each coupled via one of switches 332, 333, 334 and 335 through inductor 336 to the load 104. Anti-reversing diodes 340, 342 and 344 are coupled to each module 302, 304 and 306 to prevent the voltage from reversing on the capacitors and assure unidirectional current flow through the switches. This also minimizes the circulating current from one module to enter another module. Each of the switches 312, 313, 314, 315, 322, 323, 324, 325, 332, 333, 334, and 335 is a mechanical switch that can be mechanically transitioned between “open” and closed” states. These mechanical switches may comprise vacuum bottles, as discussed below with respect to FIGS. 7-10.

According to several embodiments of the invention, the capacitor units of a given module are individually switched (discharged) through the same inductor at different times such that the same inductor is pulsed multiple times when forming the output pulse waveform (i.e., multiple discharge pulses are provided to the load 104 through the same inductor to the load 104 and not through the other inductors of the other modules). Thus, in a broad sense, multiple capacitor units are non-simultaneously discharged through each inductor of the network 300. Thus, each inductor is pulsed at a higher frequency than in traditional pulse forming networks. As described more fully below, this results in the use of fewer and smaller inductors, fewer anti-reversing diodes, better pulse shaping capabilities and overall reduction in size and mass relative to known pulse forming networks. It is noted that when referring to a discharge pulse flowing through a given inductor and not through the inductors of other modules, the discharge current through the given inductor flows generally directly to the load and does not flow through the other inductors on its path to the load. For example, in the illustrated embodiment, multiple inductors are not coupled in series to the load. However, it is understood that the discharging of any given capacitor unit will result in a small amount of stray induced currents in the other inductors, which is unavoidable. Accordingly, in preferred embodiments, the discharge current (not including stray induced current) flows through the given inductor and not through the other inductors. It is also noted that in many embodiments, the inductors may be made smaller since they are pulsed more frequently, and in some cases, a discrete inductor is not needed. For example, in some embodiments, the wireline or cabling connection from a given switch to the load provides a natural inductance, which in some cases is adequate. Thus, even though an inductor is illustrated in the various figures presented herein, it is understood that in some cases the illustrated inductor represents an inductance and not necessarily a discrete inductor. As such, as used herein, the term inductor is understood to be a discrete inductor or an inductance.

According to several embodiments of the invention, the switches used to selectively discharge the capacitors are mechanically moveable. Such switches may comprise, for example, vacuum bottles that can be rapidly moved from an open to a closed position. A vacuum bottle includes contacts that are physically separated when the vacuum bottle is in an “open” state. To close the circuit, the contacts must physically touch each other to allow current to flow between them. In order to do this, one, or both of the contacts, is physically moved toward the other until they touch. The capacitor discharges at this time, and then the contacts are allowed to bounce off each other and the vacuum bottle returns to the “open” state. According to several embodiments, the vacuum bottles are operated as momentary switches. Vacuum bottles are advantageous to use as switches in this manner for a variety of reasons including, for example, their ability to handle rapid changes in current over a short time frame. That is, unlike conventional solid state or semiconductor switches, vacuum bottles or tubes are not limited by di/dt.

According to further embodiments, at least some of, but not all of the capacitor units of a given module are individually switched (discharged) through the same inductor at different times such that the same inductor is pulsed multiple times when forming the output pulse waveform. Thus, in a broad sense, at least some of multiple capacitor units coupled to each inductor of the network 300 are non-simultaneously discharged through that inductor. In cases where not all of the pulses are non-simultaneously discharged, at least two of the multiple capacitor units coupled to a given inductor are simultaneously discharged. For example, capacitor units 308 and 309 could be simultaneously discharged while all remaining capacitor units are non-simultaneously discharged with respect to each other and capacitor units 308 and 309. Each inductor is still pulsed at a higher frequency than in traditional pulse forming networks, which also results in the use of fewer and smaller inductors, fewer anti-reversing diodes, better pulse shaping capabilities and overall reduction in size and mass relative to known pulse forming networks. The combination of non-simultaneous and simultaneous pulses through a given inductor depends on the application and pulse shape that is desired.

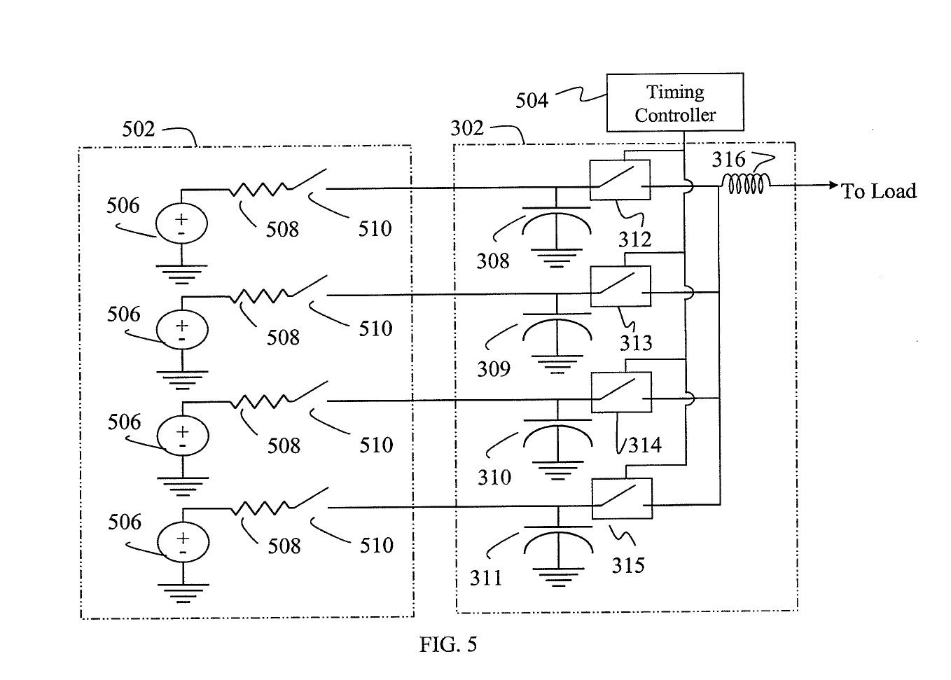

In operation, each of the capacitor units is charged to the appropriate voltage by a high voltage charging supply (such as illustrated in FIG. 5). In order to generate a waveform having a desired shape, the capacitor units are sequentially discharged in a predetermined sequence to produce that an output pulse waveform having the desired shape, such that the capacitor units of a given module are individually discharged at different times through the inductor of the given module, i.e., non-simultaneously discharged in several embodiments.

For example, in preferred embodiments, at the start of the pulse, switch 312 of module 302 is closed to discharge capacitor unit 308 through the inductor 316 to the load 104 and not through inductors 326, 336. This results in pulse 403 of FIG. 4. At a predetermined time after the closing of switch 312 (i.e., after beginning the discharge of capacitor unit 308), switch 322 of module 304 is closed to discharge capacitor unit 318 through the inductor 326 to the load 104 and not through inductors 316, 336, which results in pulse 404 of FIG. 4. Proceeding in sequence, switch 332 of module 306 is closed to discharge capacitor unit 328 through the inductor 336 to the load 104 and not through inductors 316, 326, which results in pulse 405 of FIG. 4. It is noted that switch 312 is now open. The switching sequence then continues back to module 302, such that switch 313 is closed to discharge capacitor unit 309 through the inductor 316 to the load 104 and not through inductors 326, 336, which results in pulse 406 of FIG. 4. It is preferred that the each capacitor unit of a given module completely discharge prior to the next capacitor unit of that module discharging, i.e., the pulses through a given inductor do not overlap in time. Thus, the switching timing is preferably such that pulse 406 starts after the end of pulse 403, and so on. However, in alternative embodiments, depending on the application, pulses through a given inductor may be made to overlap in time. In such alternative embodiments, one or more switches in a given module are closed such that at least a portion of the pulses going through the inductor of that module overlap each other. For example, a given capacitor unit of a given module is discharged before a voltage of an already discharging capacitor unit of that module reaches zero. This can be helpful in shaping the pulse to a desired shape for a given application. For example, if additional energy is required at a portion of the pulse, then more switches (even in the same module) are closed.

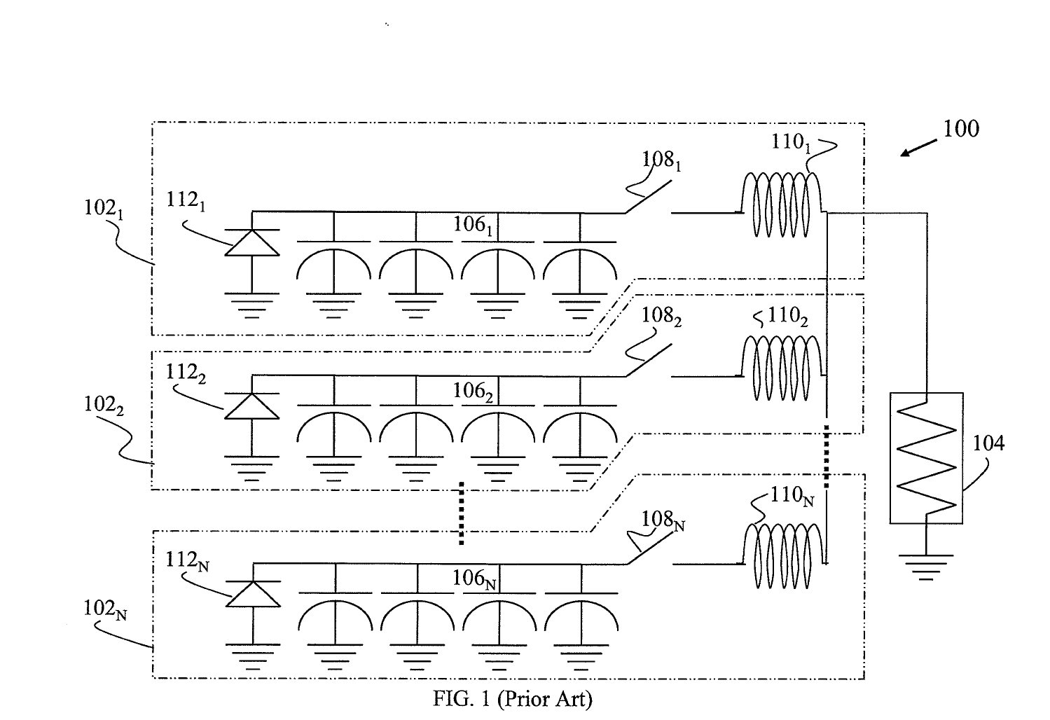

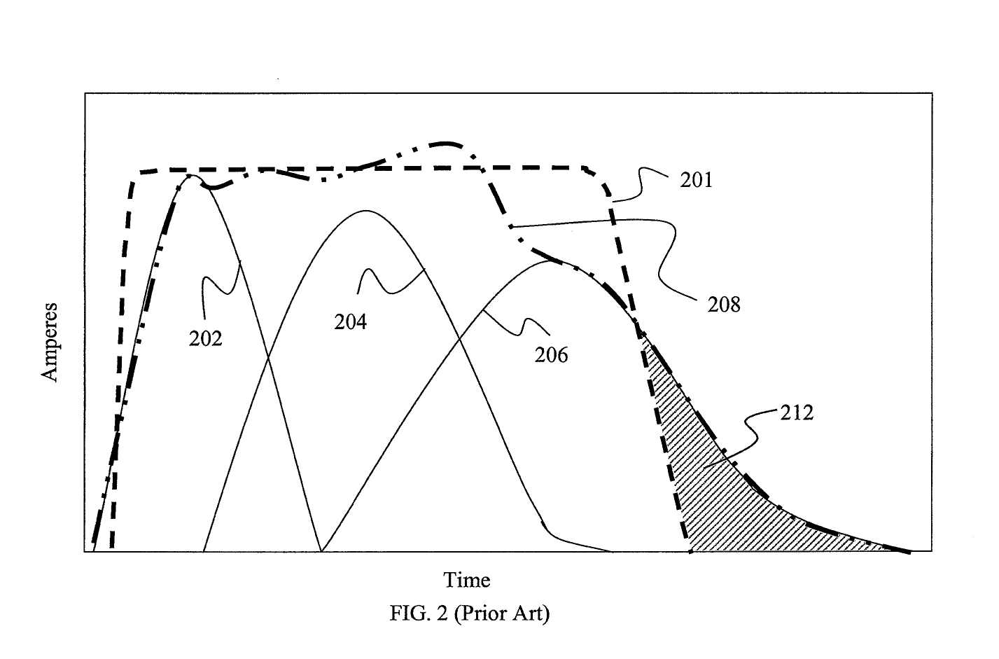

Accordingly, in one embodiment, the switching sequence is such that the switches close in the order of 312, 322, 332, 313, 323, 333, 314, 324, 334, 315, 325 and 335 in order to sequentially discharge capacitor units 308, 318, 328, 309, 319, 329, 310, 320, 330, 311, 321 and 331 in order. Thus, current pulses 403, 404, 405, 406, 407, 408, 409, 410, 411, 412, 413 and 414 are sequentially produced in time at the load. The sum of the pulses 403-414 adds to the output pulse waveform 402, which more closely follows the desired flat top waveform 201 than the traditional network of FIGS. 1-2. Such waveforms are needed for various types of loads, including charged particle accelerators, microwave sources and lasers. Thus, in preferred embodiments, a first capacitor unit of each module is sequentially discharged, then a second capacitor unit of each module is sequentially discharged, then a third capacitor unit of each module is sequentially discharged, and so on until all capacitor units of all modules are discharged. Such sequence ensures that the capacitor units of each module are non-simultaneously discharged.

In one variation of a switching sequence, the first several capacitor units of the sequence are switched or pulsed at the same time in order to decrease the rise time of the pulse. This is advantageous in creating a flat top waveform. For example, switches 312 and 322 are closed at or very near the same time to discharge capacitor units 308 and 318 through inductors 316 and 326, respectively. After this initial pulsing, the sequence proceeds as described above, with the desired interval in between discharge pulses. In other embodiments, some capacitor units, other than the first and several capacitor units, in the same circuit with a given inductor or coupled to different inductors, are switched or pulsed at the same time (simultaneously). For example, depending on the application, other capacitor units in the middle of the pulse waveform are pulsed at the same time (simultaneously). This provides additional energy at times needed for the application.

It is noted that in preferred embodiments, only one capacitor unit of a given module is switched through the inductor of that module at a time. Accordingly, less energy is switched through the inductor relative to traditional pulse forming networks. Therefore, the inductor has smaller inductance requirements, i.e., a smaller value inductor having less size and mass may be used in each module. In preferred embodiments, only one of the switches of a given module is closed at a time, while the other switches are open. For example, after switch 312 closes and completely discharges the capacitor unit 308, switch 312 naturally re-opens as a result of zero current flowing therethrough. In another example, switch 312 re-opens due to a commutation circuit that is coupled to switch 312 which forces the switch to re-open. In another example, if the switch 312 is conducting when switch 313 is closed, the closing of switch 313 will reverse the current through switch 312 to shut off or re-open switch 312. If switch 312 can be commutated, the closing of switch 313 acts as a commutation circuit to shut off switch 312.

Advantageously, since each inductor in the pulse forming network is pulsed multiple times (i.e., energy for multiple capacitor units is discharged through the same inductor) when forming the output pulse waveform, fewer inductors are required compared to a traditional pulse forming network that requires a single inductor for many modules, such as shown in FIG. 1. In FIG. 3, each inductor is pulsed 4 times per output pulse waveform, e.g., inductor 316 is pulsed 4 times (by discharges from each capacitor unit 309, 309, 310 and 311), producing pulses 403, 406, 409 and 412. In contrast, in FIG. 1, each inductor is pulsed once per output pulse waveform. Accordingly, the pulse forming network 300 of FIG. 3 including only three inductors can replace the pulse forming network of FIG. 1 having 72 inductors at the same energy level. This savings in the number of inductors represents a dramatic reduction in the size and mass of the pulse forming network. It is well known that inductors are the second largest mass component aside from the energy storage capacitor units in a pulse forming network.

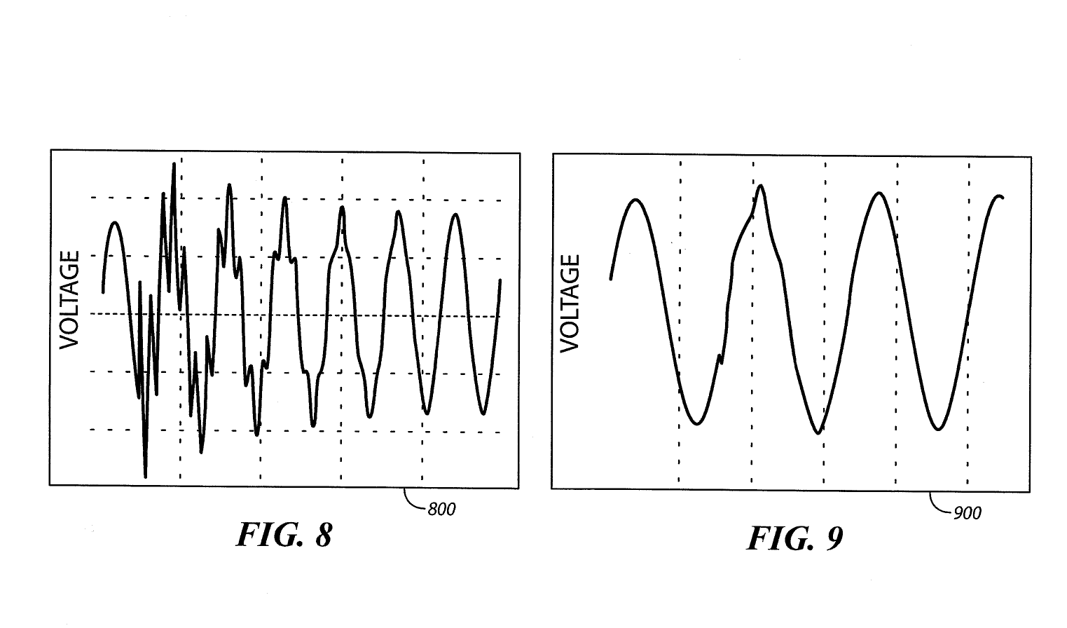

It is noted that a pulse forming network in accordance with several embodiments of the invention may be implemented with as few as two inductors (i.e., two energy storage modules), each inductor (of each module) pulsed multiple times by different capacitor units to form the output pulse waveform. However, in order to ensure that a given capacitor unit (of a given module) is fully discharged prior to discharging the next capacitor unit coupled to the same inductor (of the same module), it is desired that the pulse forming network preferably have three or more inductors (thus, three or more modules as defined). It is noted that in some embodiments, pulses through a given inductor are intended to overlap, i.e., a given switch coupling a given capacitor unit to a given inductor is closed prior to the complete discharging of a currently discharging capacitor, or prior to the completion of current through the given inductor from a previously discharged capacitor unit. However, depending on the capability of the switches, a blocking diode may be needed to prevent the switch from burning out (see FIG. 8). Additionally, it is noted that a pulse forming network in accordance with several embodiments of the invention may be implemented with as few as two capacitor units coupled to each inductor; however, in preferred embodiments, four or more capacitor units are coupled to each inductor.

Furthermore, since each inductor in the pulse forming network is pulsed at a higher frequency and switching smaller amounts of capacitance at a given time, the inductors themselves may be made smaller to handle less energy at a given time. This further reduces the size and mass of the inductors in the network relative to a traditional network, such as illustrated in FIG. 1.

The capacitor units of FIG. 3 may each comprise one or more capacitors. That is, each capacitor unit may be a single capacitor or may be a bank of capacitors in series and/or in parallel configured to provide the proper amount of energy storage. The energy storage capacitors typically comprise the largest size and mass components of the pulse forming network. Additionally, these capacitor units may be charged to different voltage levels. Such levels will be dictated by the shape of the pulse waveform to be produced by the network. For example, a particular shape waveform may be needed or the impedance of the load 104 may vary, such that changing the voltage level that some of the capacitor units are charged to will produce desired results. For example, in applications that require a fast shut off time (such as in a rail gun application), the charge voltage of the last few capacitor units (e.g., capacitor units 311, 321 and 331 in the sequence of FIG. 4) may be different than the preceding capacitor units. In some embodiments, where a fast shut off time is desired with little residual energy at the end of the pulse waveform, the last several capacitors are charged to a higher voltage than preceding capacitor units, such that the capacitance is lowered and the current through the inductor ends sooner. Thus, in a general sense, in some embodiments, one or more of the capacitor units of the pulse forming networks described herein are intentionally charged at different voltage levels. In some applications, depending on the shape of the pulse waveform to be produced, it is desired that some of the capacitor units are charged to a higher voltage level where rise and fall of current is quickly needed, whereas some of the capacitor units are charged to a lower voltage level where rise and fall of current is desired to occur more slowly. In some embodiments, there may be several different levels of voltage charge for different capacitor units. These voltage levels may be needed to help shape a particular pulse waveform or to help match the output pulse waveform to a varying impedance load. In rail gun applications and other applications where a faster shut off time is needed relative to the rise time of the pulse waveform, the voltage level of capacitor units discharging early in the sequence are charged to a lower voltage level that those capacitor units discharging later in time in the pulse waveform. In embodiments using semiconductor stacks to function as the switches, this allows for fewer switching devices (e.g., thyristors) that make up a given switch.

The switches illustrated in the energy storage modules 302, 304, 306 of FIG. 3 may each comprise one or more switches. Depending on the embodiment, the switches may be any type of switching device, preferably a switching device that can shut off (or be shut off). For example, the switches may be solid state switches, such as silicon controlled rectifiers (SCR), gate-turn-off switches (GTO), bipolar junction transistors (BJT), field effect transistors (FET), insulated-gated bipolar transistors (IGBT) or other transistor. For example, in one embodiment, each switch comprises a transistor and a diode in series (see FIG. 8) such that it behaves as an SCR. The switches may also be electromechanical switches, such as a spark gap, if the pulsing frequency is sufficient to allow the switch to turn off between pulses of the same inductor (of the same module). Even if the switch has not turned off yet, in preferred embodiments, the closing of the next switch in the same module will act to shut off the previous switch. In other embodiments, switches that are not limited by di/dt, such as vacuum tubes and spark gaps, may be utilized.

In comparison to traditional pulse forming networks, in many embodiments, the number of switches increases. However, the total energy switched will remain the same and the size and mass of the switches is normally significantly less that the size and mass of the inductors. Thus, even though there may be more switches present, the overall mass and size of the pulse forming network is reduced due to the reduction in the number and size of inductors and a reduction in the number of anti-reversing diodes.

It is also noted that compared to known pulse forming networks, the switches are grouped together. For example, in FIG. 1, each illustrated switch is a grouping of switches. Whereas according to several embodiments, the switches are spatially distributed within a given module to individually switch capacitor units. Since the switches are distributed throughout a given module, the switches are easier to cool than if the switches are bunched together. In preferred embodiments, the switches are mounted on the capacitor units, the capacitor units used to cool the switches.

Additionally, as illustrated in FIG. 3, one anti-reversing diode 340, 342, 344 is coupled to each inductor 316, 326, 336 in each energy storage module 302, 304, 306. These anti-reversing diodes (also referred to as free-wheeling diodes) primarily function to limit voltage reversal on the capacitors, which may cause the current discharged from a given capacitor unit into the inductor of that module from flowing back through the switch into the capacitor. Thus, the anti-reversing diodes limit current oscillation between the capacitor units and the load. These anti-reversing diodes also minimize current discharge from other modules from discharging into each module such that substantially all discharge current flows to the load 104, not including induced stray currents in the other inductors. That is, the discharging of one capacitor unit induces a small amount of stray current in the other inductors; however, this induced stray current is different than the discharge current from the capacitor unit. It is also noted that generally, anti-reversing diodes are not required in order to minimize current discharge from other modules from discharging into each module, since the impedance of the load 104 is generally very small relative to the impedance of the other modules. That is, the discharge current naturally flows through a given inductor directly to the load, and not through the other inductors of the other modules. Relative to the known pulse forming network of FIG. 1, since there are fewer inductors required, there are likewise fewer anti-reversing diodes required. In the example provided, 3 diodes are used in the network 300 compared to 72 diodes used in FIG. 1. This again results in a savings of size and mass in the pulse forming network 300.

In some embodiments, the anti-reversing diodes 340, 342 and 344 may be damaged by driving current through them in the opposite direction. That is, when the voltage of discharging capacitor unit 308 reaches zero, current starts flowing through the anti-reversing diode 340. If another capacitor unit is discharged while this current is flowing, it can cause current to flow in the opposite direction in the anti-reversing diode 340, which can damage the anti-reversing diode 340. In one embodiment, when an anti-reversing diode is conducting, no additional capacitor units are switched on. For example, the next capacitor unit is switched on after the anti-reversing diode 340 has shut off (i.e., space the pulses apart). In another example, the next capacitor is switched on before the anti-reversing diode begins to conduct. That is, in one embodiment, as soon as the voltage of capacitor unit 308 reaches zero volts (or just before it reaches zero volts), capacitor unit 309 is switched on, and when capacitor unit 309 reaches or approaches zero volts, capacitor unit 310 is switched on. Likewise, when capacitor unit 310 reaches or approaches zero volts, capacitor unit 311 is switched on. When capacitor unit 311 reaches zero volts, the anti-reversing diode 340 will conduct, but this is not problematic since there are no other pulses that will go through the given inductor. If the circuit switches a given capacitor unit on a little early (just before the previously switched capacitor unit reaches zero volts), there is no current through diode 340 and a trap charge is left on the previous capacitor. If the circuit switches a given capacitor unit on a little late (just after the previously switched capacitor unit reaches zero volts), a small amount of current flows through diode 340 but not enough to damage the diode 340.

It is also shown that the pulse forming network 300 according to many embodiments of the invention improves pulse shaping abilities relative to known pulse forming networks. For example, the output pulse waveform 402 of FIG. 4 more closely emulates the desired flat top output waveform 201 than does waveform 208 of FIG. 2. Furthermore, depending on the timing of the discharge switches, the designer may be able to accurately create many different pulse shapes. For example, while a square or rectangular waveform is described herein as being preferred, it is understood that it may be desired to output a triangular waveform, a waveform that ramps up or down, or other desired pulse shape depending on the application requiring the pulse. Thus, by varying the timing of discharge pulses relative to each other (controlling the switching sequence and timing), the shape of the output waveform may be varied.

The higher pulsing frequency of each inductor also provides for faster rise times according to several embodiments. That is, as seen by comparing FIGS. 2 and 4, it takes less time to go from 10% to 90% of the peak current in FIG. 4 than in FIG. 2. Faster rise times are important in microwave applications where it is desired to quickly turn on a radiation source. The ability to emulate the ideal waveform more closely results in less energy wasted in the network 300. Wasted energy is not preferred since the pulse forming network must be appropriately sized and charged to provide the needed energy as well as the un-usable wasted energy. Therefore, wasting less energy results in the ability to design a network that more closely matches the energy requirements of the load.

The higher pulsing frequency of each inductor also provides for faster shut off times according to several embodiments. Advantageously, this results less wasted energy at the end of the output pulse waveform. This wasted energy is illustrated as area 212 in FIG. 2. In contrast, depending on the timing of the discharge pulses, this wasted energy can be significantly decreased, made negligible, or eliminated. In applications such as launching electromagnetic weapons, such as rail guns excess wasted energy at the end of the pulse waveform can result in muzzle flash. By reducing or eliminating this wasted energy, flash suppressors are not required. Additionally, recovery systems (such as those used in rotating machinery based devices) are not required. Again, wasted energy is energy that must be stored by the pulse forming network 300, but which is not used. Thus, if there is less wasted energy, the energy storage components of the network 300 may be sized most closely to the requirements of the load, without having to be oversized to account for wasted energy.

Many of the advantages described above result in a pulse forming network that can be reduced in size, mass and cost while providing better performance and efficiency. For example, the inductor requirements are reduced (in terms of the number and size/mass of inductors), the diode requirements are reduced (since there are fewer inductors, fewer diodes are required), and there is a reduction in the amount of wasted energy, particularly at the end of the output waveform (which results in a reduced energy storage requirement and a smaller network).

Referring next to FIG. 5, a diagram is shown of an energy storage module of the pulse forming network of FIG. 3 including a charging power supply and a timing controller in accordance with one embodiment of the invention. Although the circuit of FIG. 3 is generalized, it is understood that additional components are needed to fully operate the pulse forming network 300. For example, a charging circuit 502 is coupled to each capacitor unit of the network (e.g., to capacitor units 308, 309, 310 and 311 as illustrated). Additionally, a timing controller 504 is coupled to each discharge switch in this module as well as the other modules (e.g., switches 312, 313, 314, 315, 322, 323, 324, 325, 332, 333, 334 and 335) in order to control the discharging sequence. It is understood that although only one module (e.g., module 302) is illustrated, all modules are similarly coupled to the charging circuit 502 and the timing controller 504.

The charging circuit 502 includes a charging power supply 506 that is coupled to each capacitor unit through a respective charging resistor 508 and a respective charging switch 510. For example, as illustrated, a separate charging power supply 506 is coupled to each capacitor unit. In operation, the charging switches 510 are closed while the discharging switches (e.g., switches 312, 313, 314, 315) are open. This allows charging current from the power supplies 506 to charge the capacitor units to the proper voltage. Such charging circuits are well known in the art.

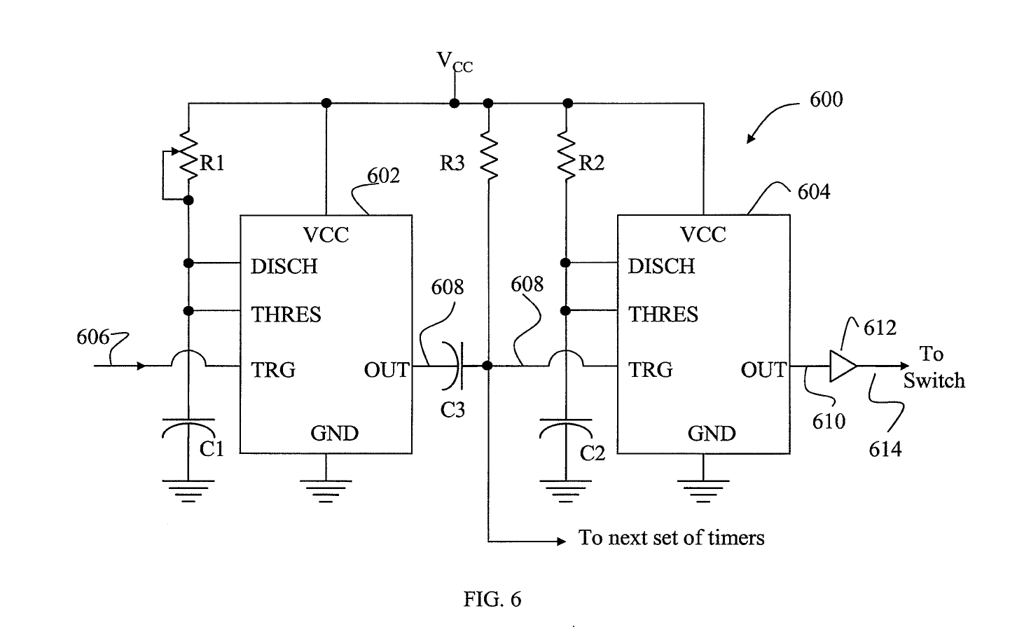

The timing controller 504 provides the necessary signaling to cause the sequential switching of the discharge switches in each module in order to discharge the capacitor units in sequence, such that the inductors are pulsed at a higher frequency than is traditionally done. In one embodiment, the timing controller 504 comprises a timing circuit including many 555 timers, a portion of which is illustrated in FIG. 6. A 555 timer is a well known integrated circuit used in applications requiring precision timing, pulse generation, sequential timing, time delay generation and pulse width modulation. A 555 timer includes two voltage dividers, a bi-stable flip flop, a discharge transistor and a resistor divider network.

Referring to FIG. 6, a diagram is shown of a portion of the timing controller 504 of FIG. 5 for controlling the discharging of a capacitor unit of the pulse forming network of FIG. 3 according to one embodiment of the invention.

In preferred embodiments, the timing circuit includes two 555 timers per discharge switch in the pulse forming network. The portion 600 of the timing circuit includes two 555 timers: timer 602 which controls the timing sequence and timer 604 which holds the switch closed during the remaining discharge sequences. Timer 602 has a capacitor C1 and a variable resistor R1 (e.g., a potentiometer) coupled thereto (at the Threshold and Discharge pins), while timer 604 has a capacitor C2 and a fixed resistor R2 coupled thereto. Power (V_{CC}) is supplied to all components. Generally, every 3 RC time constants, a 555 Timer changes state. An input trigger signal 606 is received at the timer 602 (at the trigger pin), which is used to determine the timing between pulses, while timer 604 turns on (i.e., closes) a discharge switch. For example, the output 608 of timer 602 becomes the input trigger signal to the first one of the next pair of 555 timers in the timing circuit that corresponds to the next sequential capacitor unit to be discharged. The output 608 of timer 602 is also input as the input trigger signal (at the trigger pin) to timer 604. Capacitor C3 and resistor R3 allow the output signal 608 to trigger the timer 604 and to trigger the next pair of timers in the sequence. The output 610 of timer 604 is used to activate the closing of a particular switch (and the discharging of a particular capacitor unit) and hold it in that position for a specified interval. The output 610 is amplified at amplifier 612 (e.g., an op-amp) to become the discharge timing signal 614 that is coupled to the respective switch of the network. Again, the output 608 becomes the input trigger signal 606 of the next set of timers corresponding to the next switch and capacitor unit to be discharged.

In this embodiment, each discharge switch (e.g., switch 312) comprises a transistor and a diode in series that behave as a silicon controlled rectifier (SCR) in that the switch shuts off (i.e., opens) when the discharge current from the capacitor unit reaches zero. In this embodiment, each switch of a given module is allowed to stay open in between switching so that a given capacitor is not re-charged by the discharge of another capacitor of the same module.

In order to cause the proper timing in the discharge sequence, the values of capacitors C1 and C2, variable resistor R1 and fixed resistor R2 are selected. Gross timing changes may be made by changing the capacitance C1 and C2, while fine timing changes may be made by changing the variable resistor R1 and the fixed resistor R2. The ability to generate and adjust and appropriate timing circuit is known to one of ordinary skill in the art.

In one embodiment of the pulse forming network 300 of FIG. 3, the discharge timing of the last capacitor units of the discharge sequence is varied in order to further increase the shut off time. By way of example, a pulse forming network having 4 inductors (i.e., 4 modules) is described. In this example, the components of FIG. 3 will be referred to with the addition of a fourth module (having a fourth inductor) identical to one of the other modules 302, 304, 306. The fourth module is referred to as M4 including an inductor L4, four capacitor units C1, C2, C3, C4 and four switches S1, S2, S3, S4. Accordingly, the last capacitor unit of each module (i.e., the last capacitor units in the discharge sequence, in this case, capacitor units 311, 321, 331 and C4) is discharged such that each successive capacitor pulse resonates at a higher frequency odd harmonic (which also has a lower amplitude) than the preceding discharge pulse in the sequence. This can be done in an attempt to emulate the back end of a square wave which can be expressed as the sum of an infinite number of odd harmonics each at (1/n)*sin(nα), where n is an odd integer (i.e., n=1, 3, 5, 7 . . . ). Thus, each higher frequency odd harmonic has a frequency that is n times the fundamental frequency and (1/n) times the amplitude of the fundamental frequency.

For example, the discharge pulse from capacitor unit 321 resonates at the third harmonic of the discharge pulse from capacitor unit 311 (which is at the fundamental frequency). Likewise, the discharge pulse from capacitor unit 331 resonates at the fifth harmonic of the discharge pulse from capacitor unit 311. And, the discharge pulse from capacitor unit C4 resonates at the seventh harmonic of the discharge pulse from capacitor unit 311. This is due to the well known fact that a square waveform is the sum of the odd harmonics. Accordingly, the final 4 pulses in the pulse sequence from the discharge capacitor units will add together to form a square waveform at the end of the output pulse waveform. Advantageously, this drastically reduces wasted energy at the end of the output waveform. For example, in some embodiments, the wasted energy may be reduced by as much as 70% or more.

In order that the discharge pulse from each of these last capacitor units in the pulse sequence resonates as described above, in one embodiment, the timing between subsequent pulses when discharging these last capacitor units of the sequence is successively shortened. For example, capacitor unit 321 is discharged in about half of the typical switching period. Thus, the product of the capacitance of the capacitor unit 321 and the circuit inductance 326 is reduced to 1/9 of the value for 311, 316, plus the load 104 (the capacitance inductance product) to achieve resonance at the third harmonic using the relationship

$$\frac{1}{\sqrt{L C}} .$$

Likewise, the switching period between capacitor units 331 and 321 is further decreased such that the capacitor unit 331 has effectively 1/25 of its capacitance inductance product for the fifth harmonic. And the switching period between capacitor units C4 and 331 is even further decreased such that the capacitor unit C4 has effectively 1/49 of its capacitance inductance product for the seventh harmonic. In addition, especially with the final capacitor unit C4 in the switching sequence, the inductor value may be varied since it may be difficult to adjust the capacitance of C4 to 1/49 of its value simply by decreasing the timing. For example, a portion of the inductor L4 could be shorted out (or bypassed) while decreasing the timing such that the output pulse is at the desired odd harmonic, which is easily understood to one of ordinary skill in the art.

It is understood that the exact timing provided to achieve the desired result that the last multiple pulses in the pulse sequence are odd harmonics that add to form a square wave may need to be slightly varied for a specific application to achieve the proper shut off time. Advantageously, by further decreasing the shut off time, very little energy is wasted at the end of the output pulse waveform. Thus, the energy storage requirements of the pulse forming network may be designed to more closely match that the pulse requirements of the load. That is, the pulse forming network does not have to be oversized to account for wasted energy.

According to several embodiments, mechanical switches are utilized in the designs shown in FIGS. 3 and 5. These mechanical switches provide for the rapid opening and closing of the switch to allow the capacitors to discharge without the di/dt limitations inherent in solid state and semiconductor switches. For example, the switches may each comprise a vacuum bottle which is a mechanically actuated vacuum switch. FIG. 7 illustrates a vacuum bottle 700 according to at least one embodiment of the invention. As shown, the vacuum bottle includes an upper contact 705 and a lower contact 710. When the upper contact 705 and the lower contact 710 are not physically touching each other, such as that shown in FIG. 7, the switch created by the vacuum bottle 700 is in the open position such that no current flows between the upper contact and the lower contact. However, the upper contact 705 and the lower contact 710 may move relative to each other in order to close the switch. In some embodiments, only the upper contact 705 moves, i.e., the upper contact moves down to touch a stationary lower contact 710. In other embodiments, both the upper contact 705 and the lower contact 710 move. In additional embodiments, the upper contact 705 is stationary and only the lower contact 710 is movable. The upper contact 705 is coupled to an upper contact rod 715, and the lower contact is coupled to a lower contact rod 720. The upper contact rod 715 is coupled to a bellow 725 through which the upper contact rod 715 extends. The upper contact rod 715 is also coupled to an upper shaft 730, and the lower contact rod is coupled to a lower shaft 735.

The vacuum bottle 700 also includes a porcelain housing 740 surrounding the upper contact rod 715 and the lower contact rod 720. A volume 742 formed within the porcelain housing 740 is maintained in a vacuum. It should be appreciated that some material other than porcelain may also be utilized for the housing. The vacuum bottle 700 further includes a splatter shield 745. The splatter shield 745 protects the vacuum bottle from damage when the upper contact 705 and the lower contact 710 come into contact. When the upper contact 705 and the lower contact 710 come into contact with each other, metal from their respective surfaces is often boiled off. The splatter shield 745 protects the rest of the vacuum bottle 700 from this boiling metal.

The vacuum bottle 700 further includes an upper shaft movement device 750 or actuator to move the upper shaft 730 to close and open the circuit formed by the upper contact 705 and the lower contact 710. In embodiments where the lower shaft 735 is mechanically moveable, a lower shaft movement device 750 or actuator may be utilized to move the lower shafts to close and open the circuit formed by the upper contact 705 and the lower contact 710.

In some embodiments, a separate vacuum bottle 700 of FIG. 7 may be used in the place of one or more of the switches shown in, for example, FIGS. 3 and 5. An advantage of using a vacuum bottle 700 as a switch is that a current level flowing through a vacuum tube can rapidly change over a short period of time after the upper contact 705 and the lower contact 710 come into contact. That is, the vacuum bottle 700 is not limited by di/dt, like many known semiconductor switches. For example, the upper contact 705 and the lower contact 710 may come into contact to “slam” the switch closed for about 2 milliseconds and then be allowed to bounce open. As described above, when the contacts are slammed together, they have a tendency to bounce back open. Previous systems intentionally eliminate this bouncing effect to maintain the switch in a closed position for a period of time. By allowing the contacts to bounce back open, the circuit is rapidly opened after discharging the capacitor. Thus, the switch is in a closed state for a very short period of time such that the vacuum bottle is operated as a momentary switch. In contrast, depending on the switching application, where high amounts of current are to be switched through a switch in a short amount of time (such as several embodiments of the pulse forming networks described herein), if semiconductor switches are used that are limited due to di/dt, such switches may not perform satisfactorily or may fail. Vacuum bottles and other switches not limited by di/dt may be used instead and provide better results.

The operation of such vacuum bottles as a momentary switch is in contrast with the typical operation of vacuum bottles as switches that have been used in previous unrelated systems. Such vacuum bottles in previous unrelated systems are made to remain in a closed state for extended periods of time, for example, several seconds. However, Applicants are aware of one use of vacuum bottles in an electric utility line as an interrupter/reclosure mechanism which senses overcurrents to time and interrupt fault currents and then re-closes to re-energize the line. That is, the switch is normally closed, but opens upon the detection of an overcurrent or a fault current, then attempts to reclose to re-energize the line after the interruption. If the fault is permanent, the re-closure of the vacuum bottle locks open after being in a closed state for about 3-4 cycles of a 60 Hertz signal, i.e., the switch remains closed for about 50 milliseconds at a minimum and in only limited circumstances. Most of the time, in this application, and in many applications, the vacuum bottle remain in a closed state for significantly longer periods of time.

Referring back to FIG. 3, a vacuum bottle 700 may be used in the place of each of the illustrated switches to allow for the efficient discharging of the capacitors. The contacts in each of the vacuum bottles are sequentially closed and then opened. As discussed above, the contacts may be closed for about 2 milliseconds and then allowed to bounce back open. In an embodiment of the invention, there is no attempt to dampen this bouncing effect as in typically done with current vacuum bottles used for other applications.

The contacts in a particular vacuum bottle are opened back up before contacts in the next vacuum bottle in the order are closed. In one embodiment, such as in the pulse forming networks described above, the entire process of rapidly closing and then re-opening the vacuum bottles 700 of the pulse forming network is repeated, for example, every six seconds. An individual vacuum bottle is certainly capable of reclosing again sooner than this period of time, however, in some embodiments of the described pulse forming networks, the switches of each module sequentially discharge together with switches or other modules.

In other embodiments, a spark gap could also be used instead of a vacuum bottle. A spark gap does not have any moving parts. Instead, a closed circuit may be formed by changing the air pressure within the spark gap. However, the flow of electric charge through the spark gap is difficult to control unless a complex design is utilized. Oil switches may also be utilized in other embodiments.

As discussed above, the vacuum bottles may be utilized as momentary switches in at least one embodiment of the invention. It should be appreciated, however, that other types of momentary switches may be utilized that also lack the di/dt limitations of solid state or semiconductor switches. In general, any type of switch may be utilized that can rapidly be switched from an open state to a closed state to allow a capacitor to discharge, and then rapidly back to an open state without experiencing the di/dt limitations common to solid state or semiconductor switches. The time duration of the closed state of the momentary switch varies depending on the particular application. In some embodiments, a momentary switch may be utilized that remains in a closed state for about 50 milliseconds or less. In other embodiments, a momentary switch may be utilized that remains in a closed state for about 40 milliseconds or less. In additional embodiments, a momentary switch may be utilized that remains in a closed state for about 30 milliseconds or less. In further embodiments, a momentary switch may be utilized that remains in a closed state for about 20 milliseconds or less. In other embodiments, a momentary switch may be utilized that remains in a closed state for about 10 milliseconds or less. In further embodiments, a momentary switch may be utilized that remains in a closed state for about 5 milliseconds or less. In a preferred embodiment of a pulse forming network, such as in some embodiments described herein, a momentary switch may be utilized that remains in a closed state for about 2 milliseconds. In the case of a vacuum bottle, the switch may be closed by a mechanical actuator and then allowed to bounce back open. In other embodiments, where a slightly longer duration closed state is needed, the mechanical actuator may be used to dampen or hold the switch in the closed state for the desired length of time.

FIG. 8 illustrates a chart 800 of what the voltage output waveform resulting from closing all three switches on a 3-phase bank of capacitors without coordinating the closing of the switches. As shown, the waveform is very choppy due to the fact that the opening of switches in communication with the capacitor is not properly synchronized.

FIG. 9 illustrates the voltage output waveform 900 resulting from closing all three switches on a 3-phase bank of capacitors with coordinating the closing of the switches. As shown, by coordinating the timing of when the switches coupled to each of the capacitors is closed and opened, a desirable smooth waveform is achieved. For a 3-phase system, 0.3 milliseconds after the voltage difference is zero. The accuracy is ±0.75 milliseconds.

Referring next to FIG. 10, a flowchart is shown illustrating the steps performed in accordance with one embodiment of the invention. This method may be performed, for example, by any of the pulse forming networks described herein.

Initially, a pulse forming network is provided having a plurality of capacitor units, wherein multiple capacitor units are coupled to each of a plurality of inductors, each inductor coupled to a load (Step 1002). For example, the networks of FIGS. 3 and 5 may be provided; however, it is understood that other pulse forming networks than those specifically described herein may be used. Next, each of the capacitor units is charged to an appropriate voltage level (Step 1004). Such may be accomplished by coupling the capacitor units to an appropriate charging power supply.

Next the pulse forming network is ready to be discharged to form the output pulse waveform to a load. First, timing control signals are generated to control the sequential discharging of the capacitor units in the desired sequence at the proper timing (Step 1006). In one embodiment, a timing controller is used to generate such timing control signals and output them to the respective switches, which when closed, will discharge a particular capacitor unit. For example, a timing circuit such as described in FIG. 6 may be used.

As a result of the timing control signals, the multiple capacitor units coupled to each inductor are non-simultaneously discharged to provide multiple non-simultaneous pulses through each inductor to the load and not through other inductors coupled to the load (Step 1008). As described above, this is understood to mean that the discharge current from a given capacitor unit discharged to form a given pulse flows through its given inductor to the load and not through other inductors on its path to the load (not including stray currents induced in each of the other inductors when discharging the given capacitor unit). Accordingly, each of the inductors is coupled to the load such that the current flowing therethrough does not pass through the other inductors on its path to the load. For example, in preferred embodiments, multiple inductors are not coupled in series to the load. Furthermore, the impedance of the load is very small relative to the impedance of the other inductors such that the discharge current from a given capacitor unit naturally flows through a given inductor directly to the load, and not through the other inductors. It is further noted that the load includes an inductance; however, this load inductance is distinct from the discharge inductors that are each coupled to the load.

For example, in FIG. 3, capacitor units 308, 309, 310 and 311 are discharged at different times. In preferred embodiments, the pulses through a given inductor do not overlap in time. For example, in one embodiment of FIG. 4, the pulses 403, 406, 409 and 412 do not overlap in time. In other embodiments, at least a portion of one or more of the pulses through a given inductor overlap in time, e.g., pulses 403 and 406 may overlap in time. In one embodiment, the multiple capacitor units are each discharged by the non-simultaneous closing of respective switches coupled to the multiple capacitor units.

It is noted that in some embodiments, as a result of the timing control signals, at least two of the multiple capacitor units are simultaneously discharged to provide at least two simultaneously discharged pulses through each inductor to the load and not through other inductors coupled to the load. Thus, in a broad sense, Step 1008 provides that at least some (and in some embodiments, all) of the multiple capacitor units coupled to each inductor are non-simultaneously discharged to provide multiple non-simultaneous pulses through each inductor to the load and not through other inductors coupled to the load.

Furthermore, in some embodiments, capacitor units coupled to different inductors are discharged at substantially the same time. That is, some capacitor units coupled to different inductors may be discharged at or near the same time. For example, during the first pulses of the sequence, the first two capacitor units of the sequence (each coupled to different inductors) are discharged at or near the same time in order to decrease the rise time of the pulse in order to better emulate a flat top pulse waveform.

Furthermore, in preferred embodiments, groups of the multiple capacitor units coupled to a respective inductor each comprise one of a plurality of energy storage modules. According to one example, a discharge sequence is provided where given capacitor unit of each energy storage module is sequentially discharged over time to provide a given pulse through each inductor. Then, after beginning the discharging of the given capacitor unit of the last sequential module, a subsequent capacitor unit of each energy storage module is sequentially discharged over time to provide a subsequent pulse through each inductor to the load. For example, in one embodiment of FIG. 3, capacitor units 308, 318 and 328 are sequentially discharged. Then, after beginning to discharge capacitor unit 328, capacitor units 309, 319 and 329 are sequentially discharged. Then, after beginning to discharge capacitor unit 329, capacitor units 310, 320 and 330 are sequentially discharged.

Furthermore, in some embodiments, the discharge timing is such that the last capacitor units in the discharging sequence are discharged at a successively higher frequency to produce the last pulses of a pulse sequence, such that each of the last pulses resonates at a higher frequency odd harmonic relative to a preceding pulse. Accordingly, the sum of the last pulses in the sequence substantially form a square waveform. This results in a faster shut off time for the output pulse waveform. For example, in one embodiment of FIG. 3, capacitor unit 321 is discharged through inductor 326 sooner such that the resulting pulse resonates at a third odd harmonic of the pulse from capacitor unit 311, while capacitor unit 331 is discharged through inductor 336 successively sooner such that the resulting pulse resonates at a fifth odd harmonic of the pulse from capacitor unit 311. This may be affected by changing the timing of the appropriate signals that cause the last multiple capacitor units to discharge.

In additional embodiments, the timing of the discharging of the capacitor units in the sequence of discharging is controlled in order to provide the proper pulse waveform. This timing can be made to vary or be adjusted over the course of the pulse depending on the shape of the pulse waveform or the impedance of the load. For example, if the waveform is a triangular waveform, the time interval between the discharging of successive capacitor units may decrease until the midway point, then begin to increase as the pulse waveform ramps down. Furthermore, in applications in which the load is a variable impedance load, such as in a rail gun application, the timing may be adjusted to account for the variable impedance of the load. In one example, in a rail gun application, the time interval between the discharging of successive capacitor units is increased or decreased as the impedance of the load changes in order to keep a constant acceleration of the projectile. In one embodiment, as the impedance increases, the time interval between the discharging of successive capacitor units is decreased.

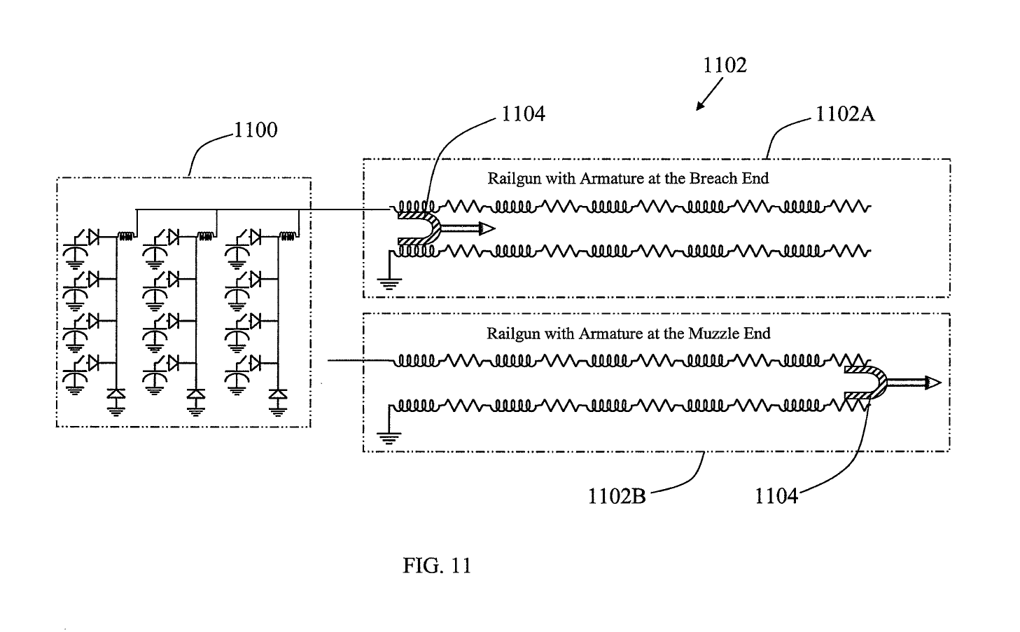

FIG. 11 is a schematic diagram of a rail gun application using a pulse forming network to provide energy to launch a projectile in accordance with several embodiments. A pulse forming network 1100, which can be any of the networks described herein, provides pulsed energy to the rail gun apparatus 1102. A rail gun is a launching device that moves an armature 1104 or projectile along two rails of a launch barrel and projects the armature at high speed out of the barrel. The current pulses from the network 1100 are coupled to the rails of the rail gun at the breach end. Each rail has a variable impedance, which is illustrated as a series of resistances and inductances. Accordingly, the rail gun is a variable impedance load. 1102A illustrates the armature at the breach end. When energy is applied to the rails, the armature is accelerated through the barrel and projected out of the barrel. 1102B illustrates the armature at the muzzle end of the barrel as it is leaving the barrel. In this application, it is desirable that the network 1100 produce relatively square pulse waveform with as little residual energy left at the end of the pulse, which is timed to occur as the armature reaches the muzzle end of the rail gun. Excess energy in the rails at the muzzle end results in muzzle flash, which requires the use of muzzle suppressors. As described above, according to many embodiments, the pulse forming networks described herein produce considerably less wasted energy (e.g., see wasted energy 212 of the conventional pulse forming network of FIG. 2). In many embodiments, there is a 50% or more reduction in wasted energy, which in this application, wasted energy at the muzzle may result in muzzle flash.

Teachings discussed herein are directed to a system for generating pulsed power to perform a predefined function. The system includes a pulse forming network having a plurality of inductors adapted to be coupled to a load, a plurality of capacitor units and a plurality of momentary switches, each momentary switch coupling a respective capacitor unit to a respective inductor. Multiple capacitor units are coupled to each inductor by separate momentary switches and are adapted to be switched to a closed position to discharge the respective capacitor unit for a time interval of less than about 50 milliseconds. The plurality of momentary switches are adapted to non-simultaneously discharge at least some of the multiple capacitor units to provide non-simultaneous pulses through a given inductor to the load and not through other inductors.

The system includes a timing controller to control switching of the separate momentary switches. An apparatus is adapted to receive the non-simultaneous pulses from the pulse forming network and perform a predefined function based on receipt of the non-simultaneous pulses.

The momentary switches may be selected from the group consisting of: vacuum bottles, oil switches, and spark gaps. The momentary switches are not limited by di/dt.

The apparatus may comprise a railgun. In some embodiments, the railgun has an armature at a breach end of the railgun. In other embodiments, the railgun has an armature at a muzzle end of the railgun. The predefined function comprises launching a projectile out of a railgun based on receipt of the non-simultaneous pulses.

Teachings discussed herein are further directed to a method of operating a mechanically moveable switch. Contacts of the mechanically moveable switch are closed, thereby coupling two electrical components, to allow energy to conduct through the mechanically moveable switch. The mechanically moveable switch is then opened such that a period of time that the mechanically moveable switch is in a closed state is less than about 50 milliseconds.

The period of time that the mechanically actuated vacuum switch is in the closed state may be less than about 40 milliseconds, less than about 20 milliseconds, less than about 10 milliseconds, less than about 5 milliseconds, or about 2 milliseconds.

The mechanically actuated vacuum switch may be utilized in a capacitor based pulse forming network. The mechanically actuated vacuum switch may be opened without dampening.

While the invention herein disclosed has been described by means of specific embodiments and applications thereof, numerous modifications and variations could be made thereto by those skilled in the art without departing from the scope of the invention set forth in the claims.

What is claimed is:

1. A capacitor based pulse forming network comprising:
a plurality of inductors adapted to be coupled to a load;
a plurality of capacitor units;
a plurality of switches, each switch coupling a respective capacitor unit to a respective inductor, wherein multiple capacitor units are coupled to each inductor by separate switches and are adapted to be switched to a closed position to discharge the respective capacitor unit for a time interval of less than about 50 milliseconds; and
the plurality of switches are adapted to non-simultaneously discharge at least some of the multiple capacitor units to provide non-simultaneous pulses through a given inductor to the load and not through other inductors.

2. The capacitor based pulse forming network of claim 1, wherein each of the plurality of switches comprises a momentary switch.

3. The capacitor based pulse forming network of claim 2, wherein the momentary switch is selected from the group consisting of: a vacuum switch, an oil switch, and a spark gap.

4. The capacitor based pulse forming network of claim 1, each of the plurality of switches not being limited by di/dt.

5. A method of operating a mechanically moveable switch, comprising:
closing contacts of the mechanically moveable switch, coupling two electrical components, to allow energy to conduct through the mechanically moveable switch; and
opening the mechanically moveable switch such that a period of time that the mechanically moveable switch is in a closed state is less than about 50 milliseconds.

6. The method of claim 5, wherein the period of time that the mechanically moveable switch is in the closed state is less than about 40 milliseconds.

7. The method of claim 5, wherein the period of time that the mechanically moveable switch is in the closed state is less than about 20 milliseconds.

8. The method of claim 5, wherein the period of time that the mechanically moveable switch is in the closed state is less than about 10 milliseconds.

9. The method of claim 5, wherein the period of time that the mechanically moveable switch is in the closed state is less than about 5 milliseconds.

10. The method of claim 5, wherein the period of time that the mechanically moveable switch is in the closed state for about 2 milliseconds.

11. The method of claim 5, further comprising utilizing the mechanically moveable switch in a capacitor based pulse forming network.

12. The method of claim 5, further comprising opening, without dampening, the mechanically moveable switch.

13. The method of claim 5, wherein the mechanically moveable switch comprises a mechanically moveable vacuum switch.

14. A system for generating pulsed power to perform a predefined function, comprising:
a pulse forming network having a plurality of inductors adapted to be coupled to a load, a plurality of capacitor units and a plurality of momentary switches, each momentary switch coupling a respective capacitor unit to a respective inductor, wherein
multiple capacitor units are coupled to each inductor by separate momentary switches and are adapted to be switched to a closed position to discharge the respective capacitor unit for a time interval of less than about 50 milliseconds; and
the plurality of momentary switches are adapted to non-simultaneously discharge at least some of the multiple capacitor units to provide non-simultaneous pulses through a given inductor to the load and not through other inductors;
a timing controller to control switching of the separate momentary switches;
an apparatus to receive the non-simultaneous pulses from the pulse forming network and perform a predefined function based on receipt of the non-simultaneous pulses.

15. The system of claim 14, wherein the momentary switches are selected from the group consisting of: vacuum bottles, oil switches, and spark gaps.

16. The system of claim 14, each of the plurality of momentary switches not being limited by di/dt.

17. The system of claim 14, wherein the apparatus is a railgun.

18. The system of claim 17, wherein the railgun has an armature at a breach end of the railgun.

19. The system of claim 17, wherein the railgun has an armature at a muzzle end of the railgun.

20. The system of claim 14, wherein the predefined function comprises launching a projectile out of a railgun based on receipt of the non-simultaneous pulses.

21. A method of utilizing a capacitor based pulse forming network, the method comprising:
non-simultaneously switching each of a plurality of switches to a closed position, each switch coupling a respective one of a plurality of capacitor units to a respective one of a plurality of inductors, the inductors being coupled to a load, wherein multiple capacitor units are coupled to each inductor by separate ones of the plurality of switches,
discharging each respective one of the plurality of capacitor units when each switch is in a closed position;
switching each of the plurality of switches to an open position such that a time interval in the closed position is less than about 50 milliseconds; and
providing non-simultaneous pulses through a given inductor to the load and not through other inductors.
